(19) United States
(12) Patent Application Publication
(10) Pub. No.: US 2006/0115002 A1
(43) Pub. Date: Jun. 1, 2006

(54) Pipelined deblocking filter

(75) Inventors: Yun-Kyoung Kim, Yongin-City (KR); Jung-Sun Kang, Sungnam-City (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/226,563

(22) Filed: Sep. 14, 2005

(30) Foreign Application Priority Data
Dec. 1, 2004 (KR) 2004-0099724

(51) Int. Cl. H04B 1/66; H04N 11/04; H04N 7/12; H04N 11/02

(52) U.S. Cl. 375/240.29; 375/240.24; 375/240.18

(57) ABSTRACT

An apparatus and method for pipelined deblocking includes a filter having a filtering engine, a plurality of registers in signal communication with the filtering engine, a pipeline control unit in signal communication with the filtering engine, and a finite state machine in signal communication with the pipeline control unit; and a method of filtering a block of pixel data processed with block transformations to reduce blocking artifacts includes filtering a first edge of the block, and filtering a third edge of the block no more than three edges after filtering the first edge, wherein the third edge is perpendicular to the first edge.

### BACKGROUND OF THE INVENTION

The present disclosure is directed towards video encoders and decoders (collectively “CODECs”), and in particular, towards video CODECs with deblocking filters. Pipelined filtering methods and apparatus for removing blocking artifacts are provided.

Video data is generally processed and transferred in the form of bit streams. A video encoder generally applies a block transform coding, such as a discrete cosine transform (“DCT”), to compress the raw data. A corresponding video decoder generally decodes the block transform encoded bit stream data, such as by applying an inverse discrete cosine transform (“IDCT”), to decompress the block.

Digital video compression techniques can transform a natural video image into a compressed image without significant loss of quality. Many video compression standards have been developed, including H.261, H.263, MPEG-1, MPEG-2, and MPEG-4. The proposed ITU-T Recommendation H.264| ISO/IEC14496-10 AVC video compression standard (“H.264/AVC”) offers a significant improvement in coding efficiency at the same coding qualities as compared to the previous compression standards. For example, a typical application of H.264/AVC could be wireless video on demand requiring a high compression ratio, such as for use with a video cellular telephone.

Deblocking filters are often used in conjunction with block-based digital video compression systems. A deblocking filter can be applied inside the compression loop, where the filter is applied at the encoder and at the decoder. Alternatively, a deblocking filter can be applied after the compression loop at only the decoder. A typical deblocking filter works by applying a low-pass filter across the edge transition of a block where block transform coding (e.g., DCT) and quantization was done. Deblocking filters can reduce the negative visual impact known as “blockiness” in decompressed video, but generally require a significant amount of computational complexity at the video encoder and/or decoder.

For achieving an output image most similar to an original input image, a filtering operation is used to remove the blocking artifacts through a deblocking filter. The blocking artifacts were typically not as serious in the compression standards prior to H.264/AVC because the DCT and quantization steps operated with 8*8 pixel units for the residual coding, so the adoption of a deblocking filter was typically optional for such prior standards. In the H.264/AVC standard, DCT and quantization use 4*4 pixel units, which generate much more blocking artifacts. Thus, an efficient deblocking filter is significantly more important for CODECs meeting the H.264/AVC recommendation.

### SUMMARY OF THE INVENTION

These and other drawbacks and disadvantages of the prior art are addressed by apparatus and methods for pipelined deblocking filters. An exemplary pipelined deblocking filter has a filtering engine, a plurality of registers in signal communication with the filtering engine, a pipeline control unit in signal communication with the filtering engine, and a finite state machine in signal communication with the pipeline control unit.

An exemplary method of filtering a block of pixel data processed with block transformations to reduce blocking artifacts includes filtering a first edge of the block, and filtering a third edge of the block no more than three edges after filtering the first edge, wherein the third edge is perpendicular to the first edge. The present disclosure will be understood from the following description of exemplary embodiments, which is to be read in connection with the accompanying drawings.

### BRIEF DESCRIPTION OF THE DRAWINGS

The present disclosure presents apparatus and methods for pipelined deblocking filters in accordance with the following exemplary figures, wherein like elements may be indicated by like reference characters, in which:

FIG. 1 shows a schematic block diagram for an exemplary encoder having an in-loop deblocking filter;

FIG. 2 shows a schematic block diagram for an exemplary decoder having an in-loop deblocking filter and usable with the encoder of FIG. 1;

FIG. 3 shows a schematic block diagram for an exemplary decoder having a post-processing deblocking filter;

FIG. 4 shows a schematic block diagram for an exemplary CODEC having an in-loop deblocking filter, where the CODEC is compliant with H.264/AVC; FIG. 5 shows a schematic data diagram for a basic filtering sequence according to H.264/AVC; FIG. 6 shows a schematic data diagram for a filtering sequence that meets the requirements of H.264/AVC and that is in accordance with an exemplary embodiment of the present disclosure; FIG. 7 shows a schematic block diagram for a deblocking filter in accordance with an exemplary embodiment of the present disclosure; FIG. 8 shows a schematic timing diagram for a pipelined architecture in accordance with an exemplary embodiment of the present disclosure; FIG. 9 shows a schematic block diagram for a filter circuit in accordance with an exemplary embodiment of the present disclosure; FIG. 10 shows a schematic block diagram for a filter and associated blocks in accordance with an exemplary embodiment of the present disclosure; FIG. 11 shows a partial schematic timing diagram for a pipelined architecture blocks in accordance with an exemplary embodiment of the present disclosure; and FIG. 12 shows a schematic flow diagram for a method of ordered filtering in accordance with an exemplary embodiment of the present disclosure.

### DETAILED DESCRIPTION OF PREFERRED EMBODIMENTS

The present disclosure provides deblocking filters suitable for use in video processing using H.264/AVC, including high-speed mobile applications. Embodiments of the present disclosure offer pipelined deblocking filters having higher speed and/or reduced hardware complexity.

Deblocking methods may be used in an effort to reduce blocking artifacts created through the prediction and quantization processes, for example. The deblocking process may be implemented before or after processing and generation of a reference from a current picture.

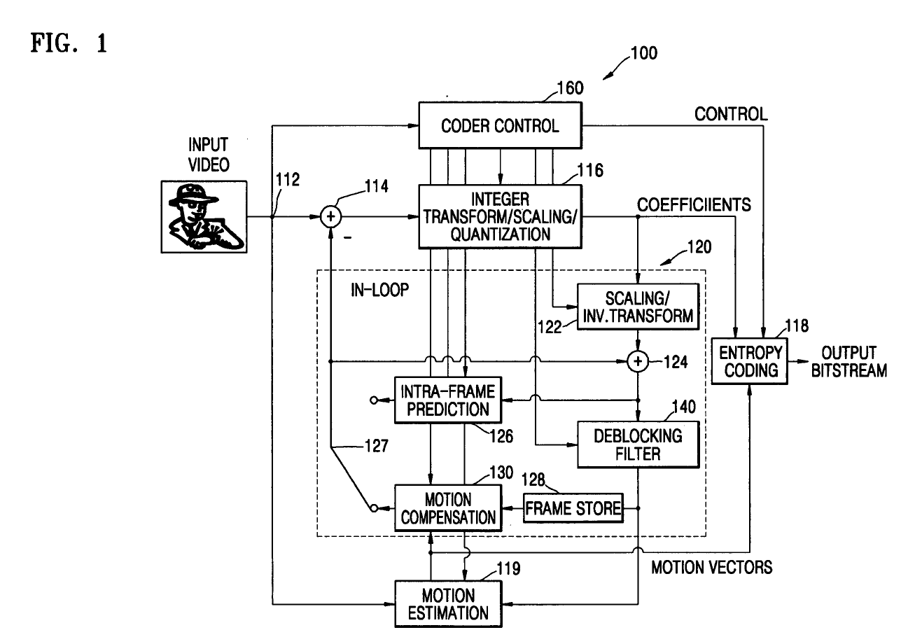

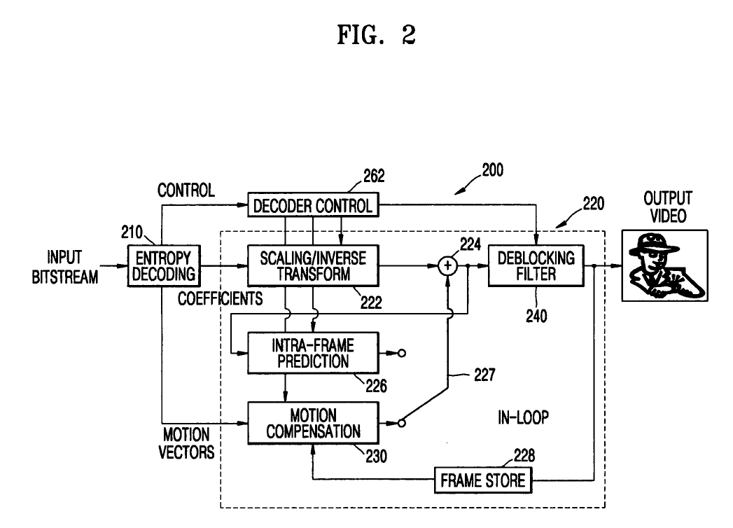

As shown in FIG. 1, an exemplary encoder having an in-loop deblocking filter is indicated generally by the reference numeral 100. The encoder 100 includes a video input terminal 112 that is coupled in signal communication to a positive input of a summing block 114. The summing block 114 is coupled, in turn, to a function block 116 for implementing an integer transform to provide coefficients. The block 116 is coupled to an entropy-coding block 118 for implementing entropy coding to provide an output bitstream. The block 116 is further coupled to an in-loop portion 120 at a scaling and inverse transform block 122. The block 122 is coupled to a summing block 124, which, in turn, is coupled to an intra-frame prediction block 126. The intra-frame prediction block 126 is switchably coupled to a switch 127, which, in turn, is coupled to a second input of the summing block 124 and to an inverting input of the summing block 114.

The output of the summing block 124 is coupled to a conditional deblocking filter 140. The deblocking filter 140 is coupled to a frame store 128. The frame store 128 is coupled to a motion compensation block 130, which is coupled to a second alternative input of the switch 127. The video input terminal 112 is further coupled to a motion estimation block 119 to provide motion vectors. The deblocking filter 140 is coupled to a second input of the motion estimation block 119. The output of the motion estimation block 119 is coupled to the motion compensation block 130 as well as to a second input of the entropy-coding block 118. The video input terminal 112 is further coupled to a coder control block 160. The coder control block 160 is coupled to control inputs of each of the blocks 116, 118, 119, 122, 126, 130, and 140 for providing control signals to control the operation of the encoder 100.

Turning to FIG. 2, an exemplary decoder having an in-loop deblocking filter is indicated generally by the reference numeral 200. The decoder 200 includes an entropy-decoding block 210 for receiving an input bitstream. The decoding block 210 is coupled for providing coefficients to an in-loop portion 220 at a scaling and inverse transform block 222. The block 222 is coupled to a summing block 224, which, in turn, is coupled to an intra-frame prediction block 226. The intra-frame prediction block 226 is switchably coupled to a switch 227, which, in turn, is coupled to a second input of the summing block 224 and to an inverting input of the summing block 214. The output of the summing block 224 is coupled to a conditional deblocking filter 240 for providing output images.

The deblocking filter 240 is coupled to a frame store 228. The frame store 228 is coupled to a motion compensation block 230, which is coupled to a second alternative input of the switch 227. The entropy-encoding block 210 is further coupled for providing motion vectors to a second input of the motion compensation block 230. The entropy-decoding block 210 is further coupled for providing control to a decoder control block 262. The decoder control block 262 is coupled to control inputs of each of the blocks 222, 226, 230, and 240 for communicating control signals and controlling the operation of the decoder 200.

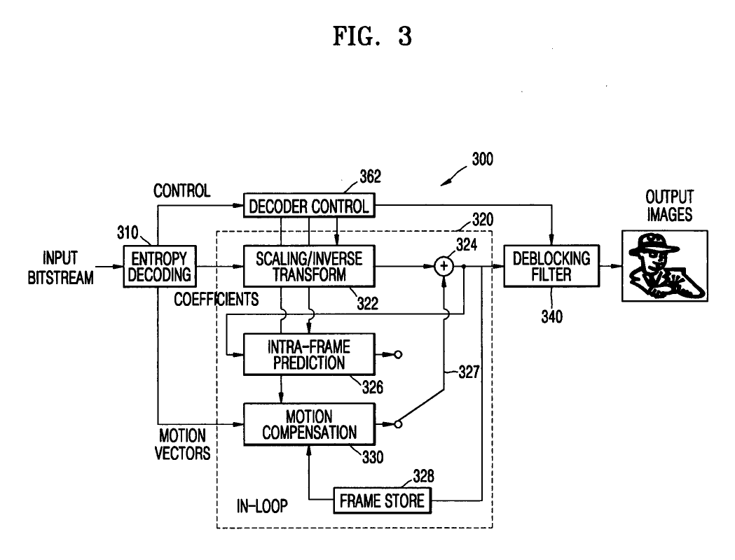

Turning now to FIG. 3, an exemplary decoder having a post-processing deblocking filter is indicated generally by the reference numeral 300. The decoder 300 includes an entropy-decoding block 310 for receiving an input bitstream. The decoding block 310 is coupled for providing coefficients to an in-loop portion 320 at a scaling and inverse transform block 322. The block 322 is coupled to a summing block 324, which, in turn, is coupled to an intra-frame prediction block 326. The intra-frame prediction block 326 is switchably coupled to a switch 327, which, in turn, is coupled to a second input of the summing block 324 and to an inverting input of the summing block 314.

The output of the summing block 324 is coupled to a conditional deblocking filter 340 for providing output images. The summing block 324 is further coupled to a frame store 328. The frame store 328 is coupled to a motion compensation block 330, which is coupled to a second alternative input of the switch 327. The entropy-encoding block 310 is further coupled for providing motion vectors to a second input of the motion compensation block 330. The entropy-decoding block 310 is further coupled for providing control to a decoder control block 362. The decoder control block 362 is coupled to control inputs of each of the blocks 322, 326, 330, and 340 for communicating control signals and controlling the operation of the decoder 300.

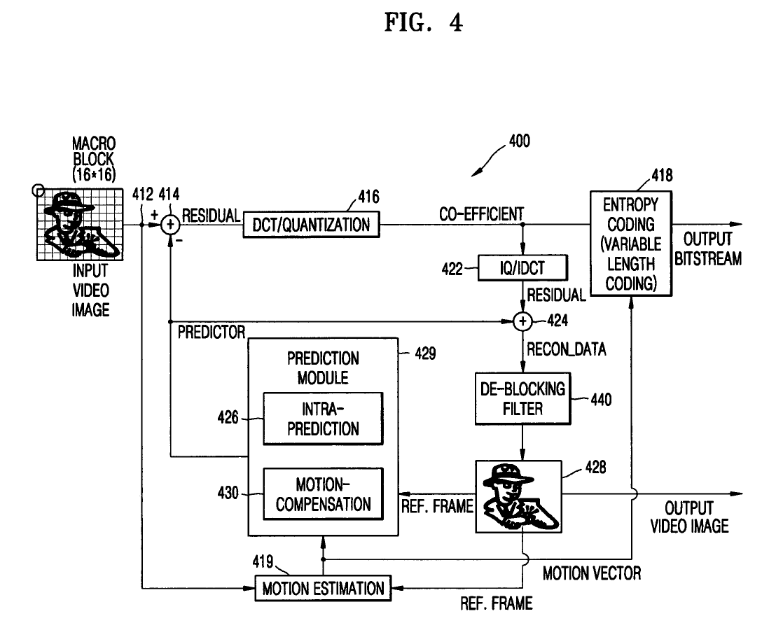

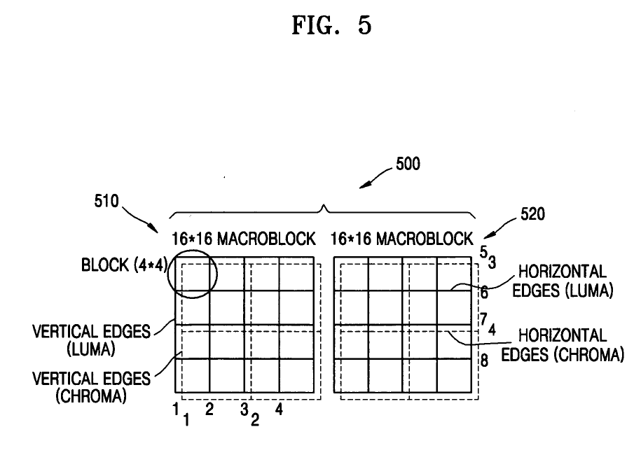

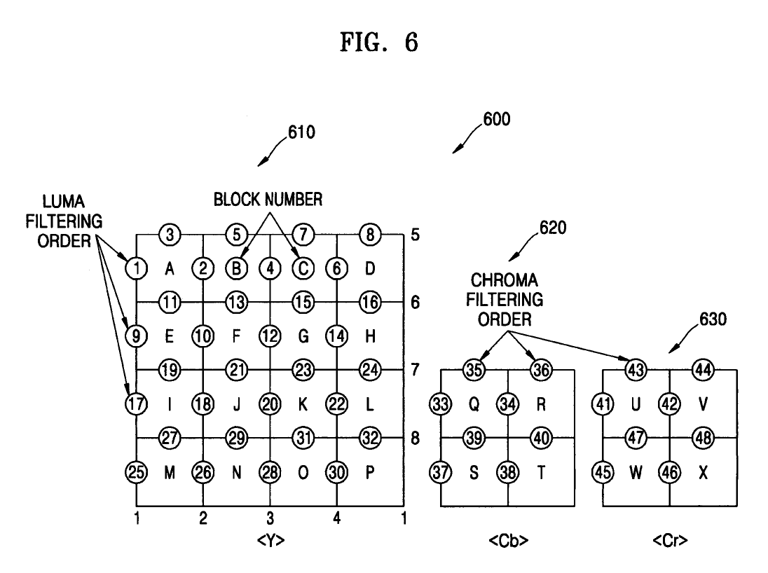

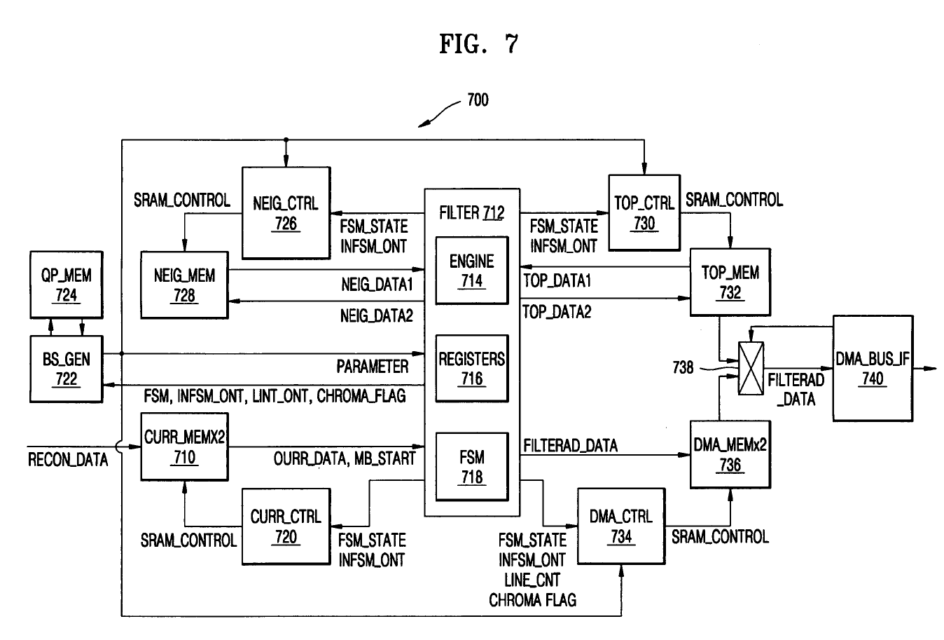

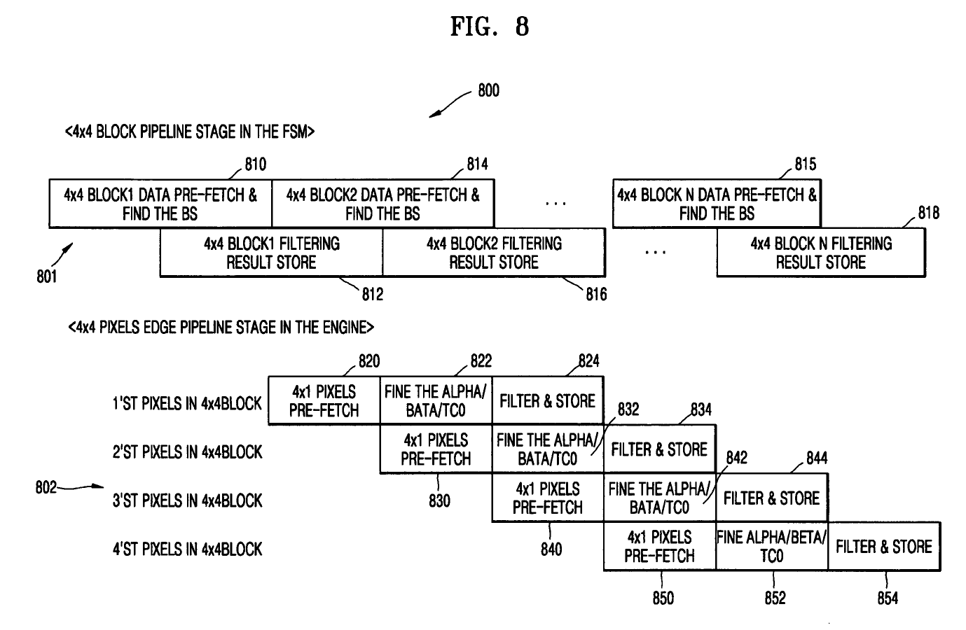

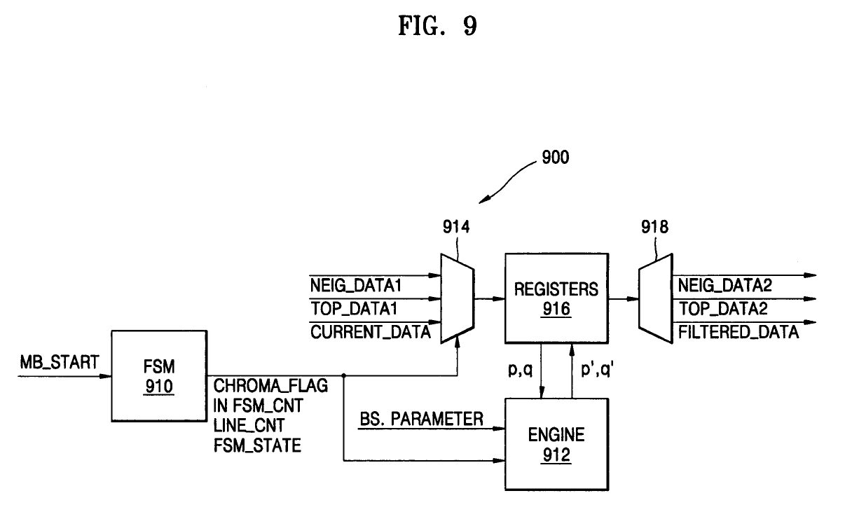

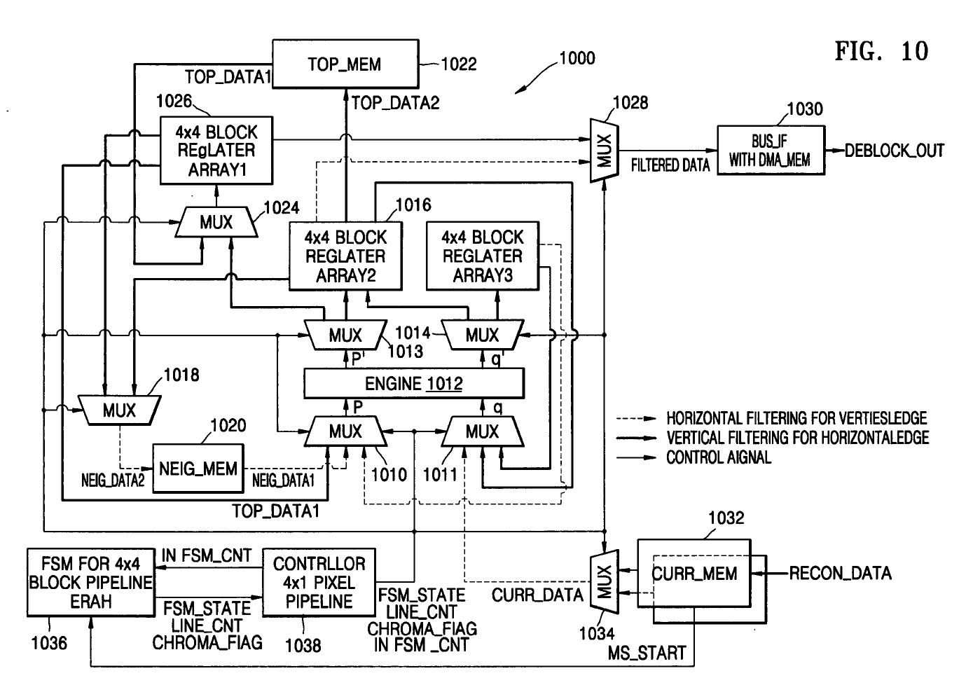

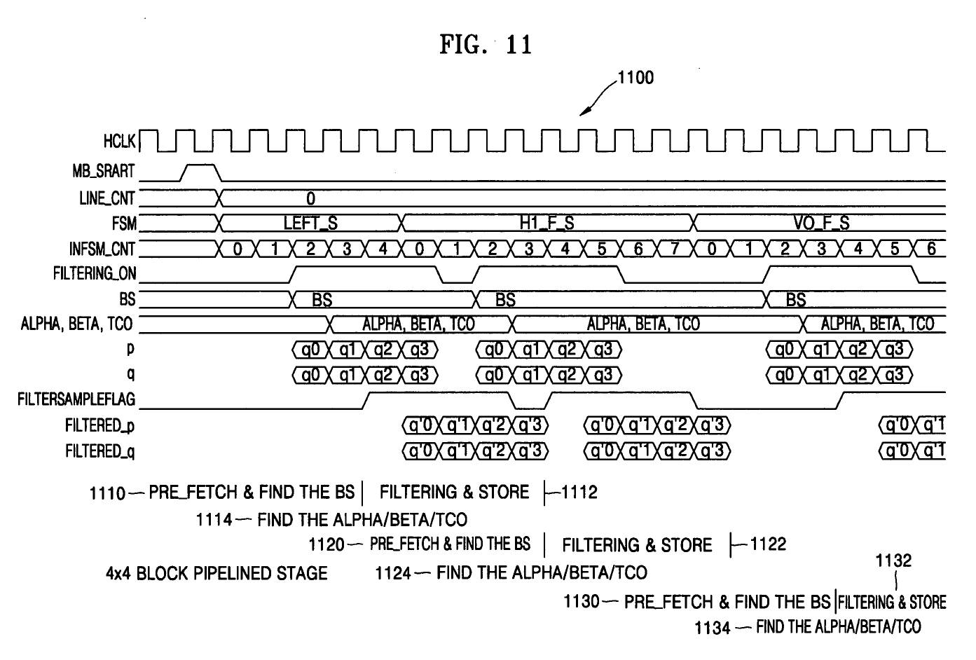

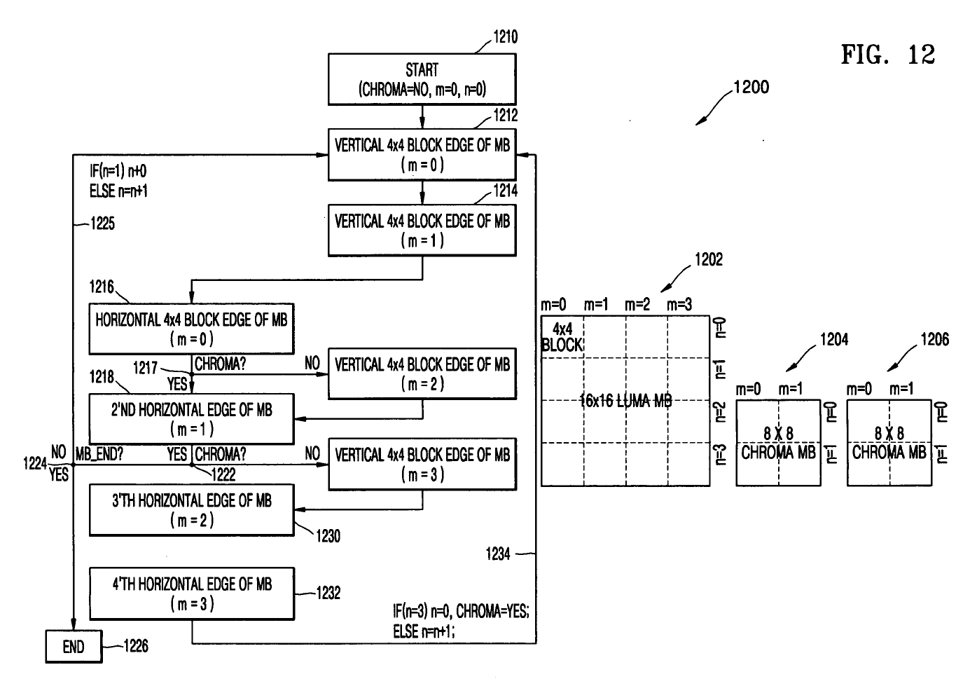

As shown in FIG. 4, an exemplary encoder having an in-loop deblocking filter is indicated generally by the reference numeral 400. The encoder 400 includes a video input terminal 412 for receiving an input video image having a plurality of macroblocks. The terminal 412 is coupled in signal communication to a positive input of a summing block 414. The summing block 414 is coupled, in turn, to a function block 416 for receiving the residual, implementing a discrete cosine transform (DCT), and quantizing (Q) the coefficients. The block 416 is coupled to an entropy-coding block 418 for implementing entropy or variable length coding (VLC) to provide an output bitstream.

The block 416 is further coupled to an inverse quantization (IQ) and inverse discrete cosine transform (IDCT) block 422. The block 422 is coupled to a summing block 424. The output of the summing block 424 is coupled to a deblocking filter 440. The deblocking filter 440 is coupled to a frame store 428 for providing an output video image. The frame store 428 is coupled to a first input of a prediction module 429, which includes a motion compensation block 430 and an intra-prediction block 426 for providing a reference frame to the prediction module 429. The frame store 428 is further coupled to a first input of a motion estimation block 419 for providing a reference frame to that block.

The video input terminal 412 is further coupled to a second input of the motion estimation block 419 to provide motion vectors. The output of the motion estimation block 419 is coupled to a second input of the prediction module 429, which is coupled to the motion compensation block 430. The output of the motion estimation block 419 is further coupled to a second input of the entropy-coding block 418. An output of the prediction module 429, which is coupled with the intra-frame prediction block 426, is coupled to a second input of the summing block 424 and to an inverting input of the summing block 414 for providing a predictor to those summing blocks.

In operation of the encoder 400 of FIG. 4, for example, an input image or frame is split into several macro blocks, which are each 16*16 pixels, and each macro block (MB) is input in order to the H.264/AVC system. The prediction module 429 investigates all macro blocks of a reference frame, which is one of the frames filtered previously, and outputs as a predictor the one most similar to the inputted MB. Thus, the predictor has pixel values that are the most similar to the current MB. A residual is the difference in pixel values between the current MB and the predictor. A co-efficient results from a DCT and a quantization operation on the residual. The co-efficient has a greatly reduced data size in comparison with the residual.

The co-efficient may be encoded to an output bit-stream through entropy coding, as in the block 418. The output bit-stream may be stored or transmitted to other systems. In addition, the co-efficient may be converted to the residual through the IQ and DCT operations. The residual is added to the predictor and is converted to reconstructed (recon) data. The recon_data has blocking artifacts or blockiness resulting from the boundaries of the macro blocks (16*16 pixels) or blocks (4*4 pixels).

Turning to FIG. 5, a filtering sequence according to H.264/AVC is indicated generally by the reference numeral 500. The sequence 500 includes horizontal filtering of the vertical edges 510 and vertical filtering of the horizontal edges 520. H.264/AVC requires that filtering be applied to all macro blocks of an image. The filtering is performed on a column and row basis, 4*16 and 16*4 pixels, respectively, of a macroblock (MB), where the macroblock is 16*16 pixels and each block is 4*4 pixels. The deblocking filter sequence according to the H.264 specification is as follows. For luminance, 4 vertical edges are filtered beginning with the left edge as shown in 510, which is called horizontal filtering. Filtering of the 4 horizontal edges follows in the same manner as shown in 520, beginning with the top edge, which is called vertical filtering. The same ordering is applied to chrominance. Thus, 2 vertical edges 510 and 2 horizontal edges 520 are filtered for Cb and Cr, respectively.

The deblocking filtering is typically a time-consuming process because of frequent memory accesses. To filter the vertical edge 2, left (previous) and right (current) column data are accessed from a buffer memory. Therefore, two accesses of 4*16 pixel data are used per edge. According to the H.264/AVC standard, after the horizontal filtering (luma steps 1, 2, 3 and 4) is completed, the vertical filtering (luma steps 5, 6, 7 and 8) is started. For performing the vertical filtering, previously accessed data from the horizontal filtering steps must be used. All blocks of 4*4 pixels in a macro block of 16*16 pixels are stored. Thus, both the filtering logic size and the filtering time are increased.

For a current example, the deblocking filtering time in a macro block should be within 500 clock cycles to appreciate a high definition image. To achieve this rate, the luma and chroma filtering may be executed in parallel to finish the filtering in time. Unfortunately, filtering circuits for both luma and chroma are required to perform the luma and chroma filtering in parallel, thus significantly increasing the size of the filtering circuit.

Turning now to FIG. 6, a pipelined filtering order of the present disclosure is indicated generally by the reference numeral 600. The order 600 includes a luma or yellow filtering order 610, a blue chroma filtering order 620 and a red chroma filtering order 630. The luma filtering order 610 includes luma-filtering steps 1 through 32 for luma blocks A through P. The blue chroma filtering order includes blue chroma filtering steps 33 through 40 for blue chroma blocks Q through T, while the red chroma filtering order includes red chroma filtering steps 41 through 48 for red chroma blocks U through X.

Here, the deblocking filtering is carried out on a divided block basis (e.g., 4*4 pixels) rather than on a row or a column basis (e.g., 4*16 for luma or 4*8 pixels for chroma) of a MB. Each edge (e.g., 4*16 pixels for luma or 4*8 pixels for chroma) is divided into several pieces (e.g., 4 pieces for luma, 2 pieces for chroma) with the presently disclosed filtering order. This order complies with the sequence, left to Right and Top to Bottom, as prescribed in the H.264/AVC specification.

The memory accesses used at one time are decreased due to the performance of the filtering operation on a block (4*4 pixel) basis rather than on a row (4*16 ) or column (16*4 ) basis. In addition, the access frequency is also reduced because the data dependence between neighboring blocks is advantageously utilized by the presently disclosed filtering order.

In operation of the filtering order 600, a left, a right and a top edge in a block (4*4 pixels) are filtered in a sequential order. For example, in the case of block F, the edges 10, 12 and 13 are filtered in that order. In addition, a bottom edge of the block (e.g., edge 21 for block F) is stored in a buffer and is then filtered as a top edge of a lower block (e.g., edge 21 is the top edge for block J).

The filtering process for the edges of the block F is as follows: First, the left edge 10 is filtered using pixel values from blocks E and F during the edge filtering for block E; new values for the E pixels are updated to a left register for filtering the upper edge 11 of the block E; and new values of the F pixels are updated to a right register. Second, the pixel values of the block G are sent to an engine for filtering from a current buffer. Third, a filtering operation about the right edge 12 is executed using blocks F and G through the engine. New pixel values for the F block are updated to the left register and new pixel values for the G block are updated to the right register. Fourth, pixel values of the block B are loaded to an upper register from a top buffer. Fifth, a filtering operation about the top edge 13 is executed using blocks B and F through the engine. New pixel values for B are updated to the upper register and new pixel values for F are updated to the left register. Sixth, a bottom edge 21 will be filtered during the edge filtering of the block J.

Thus, the previously referenced pixel values need not be stored or accessed from the memory because updating of the registers takes place shortly after computing the new pixel values without needing to store or recall them from the memory. The filtering logic is simple and the filtering time is decreased in accordance with the reduction in the memory access frequency and the use of the smaller filtering unit of block basis. It shall be understood that the order is defined separately for luma, red chroma and blue chroma. That is, the luma filtering may precede, succeed or intercede the red and blue chroma filterings, while the red may precede or succeed the blue chroma filtering, the luma filtering, or both. Thus, the presently disclosed block filtering order may be applied to various other block formats in addition to the exemplary 4:1:1 Y/Cb/Cr format.

As shown in FIG. 7, a deblocking filter in accordance with an exemplary embodiment of the present disclosure is indicated generally by the reference numeral 700. The deblocking filter 700 includes a buffer or current memory 710 for storing the reconstruction data of the current macroblock (MB). The buffer 710 is connected in signal communication with a filtering unit 712 for providing current data and MB start signals to the filtering unit. The unit 712 includes an engine 714, a block of registers 716 and a finite state machine (FSM) 718. The FSM 718 of the filtering unit 712 is connected in signal communication with a current data controller 720 for providing a FSM state and count to the controller 720. The controller 720, in turn, is connected in signal communication to the current memory 710 for providing memory or SRAM control to the memory. Filtering is performed when the reconstruction data, which is the predictor plus residual, is stored in the current memory 710.

The filtering unit 712 is connected in signal communication with BS (filtering Boundary Strength) generator 722 for providing the state, counts, and flags to the state generator. The generator 722, in turn, is connected in signal communication with a QP (Quantization Parameter of neighbor block) memory 724. The generator 722 is further connected in signal communication with the filtering unit 712 for providing parameters to the filtering unit. The filtering unit 712 is further connected in signal communication with a neighbor controller 726 for providing state and count values from the FSM 718 to the neighbor controller. The controller 726 is connected in signal communication with a neighbor memory or buffer 728 for storing neighboring 4*4 blocks. The neighbor buffer 728 receives memory or static random access memory (SRAM) control from the controller 726. The buffer 728 is connected in signal communication with the filtering unit 712, supplies first neighbor data to the filtering unit 712 and receives second neighbor data from the filtering unit.

The generator 722 is further connected in signal communication with the neighbor controller 726, a top controller 730 and a direct memory access (DMA) controller 734 for providing parameters to those controllers. The filtering unit 712 is further connected in signal communication with the top controller 730 for providing the state and count to the top controller, and with the DMA controller 734 for providing the state, counts and chroma flags to the DMA controller. The top controller 730, in turn, is connected in signal communication with a top memory 732 for providing SRAM control to the top memory. The top memory is connected in signal communication with the filtering unit 712 for providing first top data and receiving second top data from the filtering unit, where the top data is for vertical filtering. The DMA controller 734 is connected in signal communication with a DMA memory 736 for providing SRAM control to the DMA memory. The filtering unit 712 is also connected in signal communication with the memory 736 for providing filtered data to the DMA memory. Each of the top memory 732 and the DMA memory 736 are connected in signal communication with a switching unit 738, which, in turn, is connected in signal communication with a DMA bus interface 740 for providing filtered data to the DMA bus. Thus, the filtered data is transmitted to a DMA through the DMA bus interface 740.

Turning to FIG. 8, an exemplary pipeline deblocking filter architecture is indicated generally by the reference numeral 800. The pipeline architecture may be combined with the efficient filtering order to further reduce the filtering time. The deblocking filter is pipelined hierarchically into a 4*4 block stage 801 and a 4*1 pixel stage 802.

The 4*4 block pipeline stage 801 is responsive to the FSM 718 of FIG. 7. The pipeline architecture 800 includes a first block pre-fetch&find step 810 by which neighbor data are pre-fetched into registers from the neighbor buffer 728 of FIG. 7, current data are read from the current buffer 710, and the BS filtering parameter is found by generating pixel values. A first block filter&store step 812 overlaps the first block pre-fetch&find step 810. The first block filter&store 812 performs filtering, updating the registers and storing results into buffer memory. After the first block pre-fetch&find step 810 is complete, a second block pre-fetch&find step 814 is performed, and so on 815 for the remaining blocks. After the first block filter&store step 812 is complete, a second block filter&store step 816 is performed, and so on 818 for the remaining blocks. The second block pre-fetch&find step 814 overlaps both the first block filter&store step 812 and the second block filter&store step 816.

The 4*1 pixel edge pipeline stage 802 is responsive to the engine 714 of FIG. 7. The pixel edge pipeline stage 802 includes a first 4*1 pixel pre-fetch step 820 for pre-fetching a first 4*1 column of pixels for the first 4*4 block, a first 4*1 find step 822 for finding the alpha, beta and tc0 parameters for the first column of the first block after the step 820, and a first 4*1 filter&store step 824 for filtering and storing the first 4*1 column of the first 4*4 block after the step 822. The pixel edge pipeline stage 802 further includes a second 4*1 pixel pre-fetch step 830 that overlaps the step 822, a second 4*1 find step 832 that overlaps the step 824, and a second 4*1 filter&store step 834 that follows the step 832. In addition, the pixel stage 802 includes a third 4*1 pixel pre-fetch step 840 that overlaps the step 832, a third 4*1 find step 842 that overlaps the step 834, and a third 4*1 filter&store step 844 that follows the step 842; as well as a fourth 4*1 pixel pre-fetch step 850 that overlaps the step 842, a fourth 4*1 find step 852 that overlaps the step 844, and a fourth 4*1 filter&store step 854 that follows the step 852.

The pre-fetch step 820 of the 4*1 pixel stage 802, and then the find step 822 and the pre-fetch step 830 are all executed during the second pre_fetch step 814 of the 4*4 block stage 801. The filter&store step 824, the find step 832 and the pre-fetch step 840 follow the find step 822 and the pre-fetch step 830, all of which are executed in a pipelined manner during the second filtering step 816 of the block stage 801.

In operation, since the pre_fetch, find parameter and filter&store steps of the 4*1 pixel stage are executed in a pipelined manner during the filter step of the 4*4 block stage, the filtering time is significantly reduced. The pipelined deblocking filter and the new filtering order greatly reduce the filtering time. For example, after the luma filtering, the chroma filtering can be executed. Thus, only one filtering circuit is needed to minimize the hardware size.

After filtering, new pixel values are updated to corresponding registers. Referring back to FIG. 6, the main case is exemplified by the edges 2, 3, 5 . . . , etc. Here, new pixel values of a current (upper) register are updated to the current (upper) register, and new pixel values of a neighbor register are updated to the neighbor register.

Edges to be filtered horizontally after vertical filtering, such as the edges 4, 6, 12 . . . , etc., are computed differently. In the case of the circled edge number 4, for example, new pixel values of a current register, that is block B, are updated to a neighbor register. At this time, the block C pixel values are directly loaded from current memory. Before edge 4 filtering, which is just after edge 3 filtering, the neighbor register stores the block A pixel values. Thus, 8 edges (namely edges 4, 6, 12, 14, 20, 22, 28 and 30) of the 32 edges are computed this way.

Turning now to FIG. 9, a filter circuit is indicated generally by the reference numeral 900. The filtering circuit 900 includes a finite state machine (FSM) 910 connected in signal communication with an engine 912. The FSM 910 receives a MB start signal (MB_start) and provides chroma flag (Chroma_Flag), FSM count (in FSM_cnt), line count (line_cnt) and FSM state (FSM_state) signals. The FSM is further connected in signal communication with a control input of an input switch or multiplexer 914, which receives first neighbor data (neigh_data1), first top data (top_data1) or current data (current_data) and provides one of these types of data at a time to registers 916. The registers 916, in turn, are connected in signal communication with an output switch 918 for providing second neighbor data (neig_data2), second top data (top_data2) or filtered data (filtered data). The engine 912 has an input for receiving BS and parameter signals, an input for receiving current neighbor and current pixel (p and q) inputs from the registers 916, and an output for providing updated neighbor and pixel (p′ and q′) outputs to the registers 916. Here, MB_START and MB_END are flags indicative of 1 MB filtering start and end, respectively, where the output of the FSM 910 has MB_END. Chroma_Flag is a flag for indicating luma or chroma. FSM_state is an output of the FSM and signal for indicating horizontal position of current 4*4 block in a 16*16 MB. in FSM_cnt is a signal for indicating whether the 4*1 pixel pipeline stage in a block is finished. line_cnt is a signal for indicating the vertical position of a block in a MB. neig_data1 is 4*1 pixel neighbor data for the current MB horizontal filtering. neig_data2 is 4*1 pixel data for storing in a buffer for the next MB horizontal filtering. top_data1 is 4*4 top data for the current block vertical filtering. top_data2 is 4*4 pixel data for storing in a buffer for the next block vertical filtering. curr_data is the current 4*1 pixel data. filtered_data is 4*1 pixel data for which filtering is finished. p and p′ are the neighbor 4*1 pixel before and after filtering, respectively. q and q′ are the current 4*1 pixel before and after filtering, respectively. Registers comprise a register array. Engine performs the filtering operation according to the state of the FSM.

As shown in FIG. 10, a filter circuit with other blocks is indicated generally by the reference numeral 1000. The circuit 1000 includes an engine 1012 for receiving a current neighbor (p) from a multiplexer (MUX) 1010 and a current pixel (q) from a MUX 1011. The engine 1012 is connected in signal communication with each of a MUX 1013 and a MUX 1014. The MUX 1013, in turn, is connected in signal communication with a 4*4 block register array2 1016, which is connected in signal communication with a MUX 1018. The MUX 1018 provides neighbor data (neig_data2) to a neighbor memory (NEIG_MEM) 1020, which, in turn, provides other neighbor data (neig_data1) to the MUX 1010. The 4*4 block register array2 1016 is further connected in signal communication with a top memory (TOP_MEM) 1022, which is connected in signal communication with a MUX 1024. The MUX 1024, in turn, is connected in signal communication with a 4*4 block register array1 1026. The array 1026 is connected in signal communication with a MUX 1028, which is connected in signal communication with a bus interface (BUS_IF) 1030 to provide filtered data to the interface, where the interface is connected in signal communication with a DMA memory for providing deblocked output (DEBLOCK_OUT).

The circuit 1000 further includes a pair of current memories (CURR_MEM) 1032 for receiving reconstruction data (RECON_DATA). Each of the current memories 1032 is connected in signal communication with a MUX 1034, which, in turn, is connected in signal communication with the MUX 1011 for providing current data (curr_data) to the MUX 1011. The current memories 1032 are further connected in signal communication with a FSM 1036 for providing a start signal (MB_START) to the FSM 4*4 block pipeline architecture 1036. The FSM 1036 is connected in signal communication with a controller 1038 for providing the signals FSM_state, line_count and Chroma_flag to the controller 1038 and receiving in signal in FSM_count from the 1038 controller for the 4*1 pixel pipeline. The controller 1038 is connected in signal communication with the control inputs of each of the MUXs 1010, 1011, 1014, 1018, 1024, 1028 and 1034 for controlling the MUXs in response to the FSM_state, line_count, Chroma_Flag and in FSM_count signals.

In operation, the MB_START signal is generated when recon_data is stored in CURR_MEM and filtering is started. The FSM receives the control signal in FSM_cnt from the 4*1 pipeline controller to check whether the 4*1 pixel pipeline stage is finished. The Chroma_Flag signal is used because the filtering engine is shared for luma and chroma. The data filtered by the Engine are transmitted to memories or DMA through the BUS_IF.

Turning to FIG. 11, a timing diagram for the pipelined architecture is indicated generally by the reference numeral 1100. The timing diagram 1100 shows the relative timing for the signals HCLK, MB_start, line_cnt, FSM, in FSM_cnt, Filtering_ON, BS, ALPHA/BETA/TC0, p, q, filterSampleFlag, filtered_p and filtered_q, respectively.

The timing diagram 1100 further shows the 4*4 block pipelined stage, including a step 1110 to pre-fetch and find the BS for a first block, a step 1112 to perform filtering and store filtered results for the first block, a step 1114 to find the alpha beta and tc0 parameters for the first block where the step 1114 overlaps the steps 1110 and 1112, a step 1120 to pre-fetch and find the BS for a second block, a step 1122 to perform filtering and store filtered results for the second block, a step 1124 to find the alpha beta and tc0 parameters for the second block where the step 1124 overlaps the steps 1120 and 1122, a step 1130 to pre-fetch and find the BS for a third block, a step 1132 to perform filtering and store filtered results for the third block, a step 1134 to find the alpha beta and tc0 parameters for the third block where the step 1134 overlaps the steps 1130 and 1132.

In addition, the step 1120 for the second block overlaps the steps 1112 and 1114 for the first block, the step 1124 for the second block overlaps the step 1112 for the first block, and the step 1130 for the third block overlaps the block 1122 for the second block. Turning now to FIG. 12, a method of filtering in accordance with a block filtering order of the present invention is indicated generally by the reference numeral 1200. A macroblock is organized into a luma part 1202, a first chroma part 1204 and a second chroma part 1206, each with vertical edges beginning with a left edge at m=0, and each with horizontal edges beginning with a top edge at n=0.

The method 1200 includes a start block 1210 that initializes Chroma=No, m=0 and n=0. The start block 1210 passes control to a function block 1212 that filters the vertical 4*4 block edge of the MB with m=0. The block 1212 passes control to a function block 1214 that filters the vertical 4*4 block edge of the MB with m=1. The block 1214 passes control to a function block 1216. The block 1216 filters the horizontal 4*4 block edge of the MB with m=0, and passes control to a decision point 1217.

The decision point 1217 determines whether the block is a chroma block, and if so, passes control to a function block 1218. If the block is not a chroma block, it passes control to a function block 1220. The block 1220 filters the vertical 4*4 block edge of the MB with m=2, and passes control to the function block 1218. The function block 1218 filters the second horizontal edge of the MB with m=1, and passes control to a decision point 1222.

The decision point 1222 determines whether the block is a chroma block, and if so, passes control to a decision block 1224. The decision point 1224 determines whether this is the end block in the MB, and if so, passes control to an end block 1226. If not, the decision point 1224 passes control to a decision point 1225.

The decision point 1225 determines if n=1. If n=1, it resets it to n=0. If n is not equal to 1, it increments n by 1. After the decision point 1225, control is passed to the function block 1212. If, on the other hand, the decision point 1222 determines that the current block is not a chroma block, it passes control to a function block 1228. The function block 1228 filters the vertical 4*4 block edge of the MB with m=3, and passes control to a function block 1230. The function block 1230 filters the third horizontal edge of the MB with m=2, and passes control to a function block 1232. The function block 1232, in turn, filters the fourth horizontal edge of the MB with m=3, and passes control to a decision point 1234.

The decision point 1234 determines if n=3. If n=3, it resets it to n=0 and sets chroma=yes. If n is not equal to 3, it increments n by 1. After the decision point 1234, control is passed to the function block 1212.These and other features and advantages of the present disclosure may be readily ascertained by one of ordinary skill in the pertinent art based on the teachings herein. For example, it shall be understood that the teachings of the present disclosure may be extended to embodiments with luma and chroma filtering executed in parallel to further reduce the filtering time. In addition, the luma filtering may precede, succeed or intercede the red and blue chroma filterings, while the red may precede or succeed the blue chroma filtering, the luma filtering, or both. The presently disclosed block filtering order may be applied to various other block formats in addition to the exemplary 4:1:1 Y/Cb/Cr format. Although an optimized edge filtering order for a macroblock in accordance with H.264/AVC has been disclosed, it shall be understood that the general filtering order per block, which intersperses the filtering of vertical and horizontal edges, may be applied to various other types and formats of data.

It is to be understood that the teachings of the present disclosure may be implemented in various forms of hardware, software, firmware, special purpose processors, or combinations thereof. Moreover, the software is preferably implemented as an application program tangibly embodied in a program storage device. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a display unit. The actual connections between the system components or the process function blocks may differ depending upon the manner in which the embodiment is programmed.

Although illustrative embodiments have been described herein with reference to the accompanying drawings, it is to be understood that the present invention is not limited to those precise embodiments, and that various other changes and modifications may be effected therein by one of ordinary skill in the pertinent art without departing from the scope or spirit of the present invention. All such changes and modifications are intended to be included within the scope of the present invention as set forth in the appended claims.

What is claimed is:

1. A method of filtering a block of pixel data processed with block transformations to reduce blocking artifacts, the method comprising:
filtering a first edge of the block; and
filtering a third edge of the block no more than three edges after filtering the first edge, wherein the third edge is perpendicular to the first edge.

2. A method as defined in claim 1 wherein the first edge is the left edge of the block and the third edge is the top edge of the block.

3. A method as defined in claim 1, further comprising filtering a second edge of the block no more than two edges after filtering the first edge, wherein the second edge is parallel to the first edge.

4. A method as defined in claim 3 wherein the second edge is the right edge of the block.

5. A method as defined in claim 1 wherein the block comprises 4×4 pixel data.

6. A method as defined in claim 1 wherein the block is one of 16 blocks comprising a macroblock.

7. A method as defined in claim 6 wherein the blocks of the macroblock are filtered sequentially from left to right, one row at a time from the top row to the bottom row.

8. A method as defined in claim 1 wherein the block of pixel data comprises a plurality of rows, columns or vectors of pixels, the method further comprising:
pre-fetching neighbor block pixel data to a first register array;
pre-fetching current block pixel data to a second register array; and
finding the boundary strength of the current edge responsive to the pre-fetched neighbor and pre-fetched current pixel data.

9. A method as defined in claim 8, further comprising:
pre-fetching upper block pixel data to a third register array.

10. A method as defined in claim 8, further comprising:
pre-fetching a neighbor vector of pixel data from the first register array to a filtering engine;
pre-fetching a current vector of pixel data from the second register array to the filtering engine;
finding the filter parameters for the neighbor and current vectors in correspondence with the boundary strength of the current block;
filtering the neighbor and current vectors in correspondence with the filter parameters;
updating the filtered neighbor vector to the first register array; and
updating the filtered current vector to the second register array.

11. A method as defined in claim 8, further comprising:
pre-fetching a neighbor vector of pixel data from the first register array to a filtering engine;
pre-fetching a current vector of pixel data from the second register array to the filtering engine;
finding the filter parameters for the neighbor and current vectors in correspondence with the boundary strength of the current block;
filtering the neighbor and current vectors in correspondence with the filter parameters;
storing the filtered neighbor vector to a memory; and
updating the filtered current vector to the second register array.

12. A method as defined in claim 10, further comprising:
updating the first register array in correspondence with the updated second register array;
storing the updated first register array to a memory; and
pre-fetching another block of pixel data to the second register array during storing of the updated first register array to the memory.

13. A method as defined in claim 10, further comprising:
pre-fetching a second neighbor vector of pixel data from the first register array to a filtering engine during finding the filter parameters for the first neighbor vector;
pre-fetching a second current vector of pixel data from the second register array to the filtering engine during finding the filter parameters for the first current vector;
finding the filter parameters for the second neighbor and second current vectors in correspondence with the boundary strength of the current block during filtering the first neighbor and first current vectors;
filtering the second neighbor and second current vectors in correspondence with the filter parameters;
updating the second filtered neighbor vector to the first register array; and
updating the second filtered current vector to the second register array.

14. A method as defined in claim 12, the method further comprising block pipeline processing a second block of pixel data.

15. A method as defined in claim 14, block pipeline processing comprising:
pre-fetching the second block pixel data to the first register array during; and
finding the boundary strength of the block.

16. A method as defined in claim 15, block pipeline processing further comprising:
pre-fetching a second vector of pixels from the block during the finding of the filter parameters for the first vector of pixels; and
finding filter parameters for the second vector of pixels during at least one of the filtering of the first vector of pixels and the storing of the first vector of pixels.

17. A method as defined in claim 15, vector pipeline filtering further comprising:
pre-fetching another vector of pixels from the block during the finding of the filter parameters for the previous vector of pixels; and
finding filter parameters for the other vector of pixels during at least one of the filtering of the previous vector of pixels and the storing of the previous vector of pixels.

18. A method as defined in claim 1 wherein the block of pixel data comprises a row, column or vector having a plurality of pixels, the method further comprising pixel pipeline filtering the plurality of pixels.

19. A method as defined in claim 18, pixel pipeline filtering comprising:
pre-fetching a first pixel from the plurality of pixels;
finding filter parameters for the first pixel;
filtering the first pixel;
storing the first pixel;
pre-fetching a second pixel from the plurality of pixels during the finding of the filter parameters for the first pixel; and
finding filter parameters for the second pixel during at least one of the filtering of the first pixel and the storing of the first pixel.

20. A method as defined in claim 19, pixel pipeline filtering further comprising:
pre-fetching another pixel from the plurality of pixels during the finding of the filter parameters for the previous pixel; and
finding filter parameters for the other pixel during at least one of the filtering of the previous pixel and the storing of the previous pixel.

21. A pipelined deblocking filter for filtering blocks of pixel data processed with block transformations to reduce blocking artifacts, the filter comprising:
a filtering engine;
a plurality of registers in signal communication with the filtering engine;
a pipeline control unit in signal communication with the filtering engine; and
a finite state machine in signal communication with the pipeline control unit.

22. A pipelined deblocking filter as defined in claim 21 in combination with an encoder for encoding pixel data as a plurality of block transform coefficients, wherein the filter is disposed for filtering block transitions of reconstructed pixel data responsive to the block transform coefficients.

23. A pipelined deblocking filter as defined in claim 21 in combination with a decoder for decoding encoded block transform coefficients to provide reconstructed pixel data, wherein the filter is disposed for filtering block transitions of the reconstructed pixel data.

24. A pipelined deblocking filter as defined in claim 21 wherein the finite state machine is disposed for controlling a block pipeline stage of the pipelined deblocking filter.

25. A pipelined deblocking filter as defined in claim 21 wherein the engine is disposed for controlling a pixel vector pipeline stage of the pipelined deblocking filter.

26. A pipelined deblocking filter as defined in claim 21 wherein:
the finite state machine is disposed for controlling a block pipeline stage of the pipelined deblocking filter;
the engine is disposed for controlling a pixel vector pipeline stage of the pipelined deblocking filter; and
the filter is disposed for filtering a block of pixel data by filtering a first edge of the block and filtering a third edge of the block no more than three edges after filtering the first edge, wherein the third edge is perpendicular to the first edge.

27. A program storage device readable by machine, tangibly embodying a program of instructions executable by the machine to perform program steps for filtering blocks of pixel data processed with block transformations, the program steps comprising:
filtering a first edge of a block; and
filtering a third edge of the block no more than three edges after filtering the first edge, wherein the third edge is perpendicular to the first edge.

28. A program storage device as defined in claim 27, the program steps further comprising filtering a second edge of the block no more than two edges after filtering the first edge, wherein the second edge is parallel to the first edge.

29. A program storage device as defined in claim 27 wherein the block of pixel data comprises a plurality of rows, columns or vectors of pixels, the program steps further comprising:
pre-fetching neighbor block pixel data;
pre-fetching current block pixel data; and
finding the boundary strength of the current edge responsive to the pre-fetched neighbor and pre-fetched current pixel data.
